(19) United States
(12) Patent Application Publication
(10) Pub. No.: US 2014/0114514 A1
(43) Pub. Date: Apr. 24, 2014

(54) DELAYED ELECTRIC-ONLY OPERATION OF A HYBRID VEHICLE

(71) Applicant: FORD GLOBAL TECHNOLOGIES, LLC, Dearborn, MI (US)

(72) Inventors: Dale Scott Crombez, Livonia, MI (US); William David Treharne, Ypsilanti, MI (US); Paul Stephen Bryan, Belleville, MI (US); Thomas Chrostowski, Chesterfield, MI (US)

(73) Assignee: FORD GLOBAL TECHNOLOGIES, LLC, Dearborn, MI (US)

(21) Appl. No.: 13/655,805

(22) Filed: Oct. 19, 2012

(51) Int. Cl. B60W 20/00; B60W 10/08; B60W 10/06

(52) U.S. Cl. 701/22; 903/930

(57) ABSTRACT

A vehicle and a method for controlling the vehicle include a controller configured to, in response to a user command to delay electric-only operation of the vehicle, selectively operate an electric machine and an engine to propel the vehicle such that a state of charge of a traction battery electrically connected with the electric machine is generally maintained at a target value within a predefined range of states of charge. A vehicle includes a powertrain and a controller. The controller is configured to (i) operate the powertrain in a charge deplete mode and a charge sustain mode, and (ii) in response to a user request, operate the powertrain in the charge sustain mode if the state of charge is within a predefined range of states of charge when the request is received.

### TECHNICAL FIELD

Various embodiments relate to electric operation of a hybrid vehicle and methods of controlling the vehicle.

### BACKGROUND

A hybrid electric vehicle (HEV) or a plug-in hybrid electric vehicle (PHEV) has more than one source of power. An electric machine may be configured to propel the vehicle and uses a battery as a source of energy. For the PHEV, the battery may be recharged using an external power source, such as a charging station. An engine may also be configured to propel the vehicle and use fuel as a source of energy. The PHEV can be controlled to use the electric machine and/or the engine to operate the vehicle and meet user demand.

### SUMMARY

In an embodiment, a method for controlling a vehicle includes, in response to a user command to delay electric-only operation of the vehicle, selectively operating an electric machine and an engine to propel the vehicle such that a state of charge of a traction battery electrically connected with the electric machine is generally maintained at a target value if the state of charge is within a predefined range of states of charge when the user command is received.

In another embodiment, a vehicle is provided with a powertrain including an engine, an electric machine, and a traction battery electrically connected with the electric machine. The vehicle also has at least one controller configured to (i) operate the powertrain in each of a charge deplete mode in which a state of charge of the traction battery generally decreases and a charge sustain mode in which a state of charge of the traction battery is generally maintained and (ii) in response to a user request, operate the powertrain in the charge sustain mode if the state of charge is within a predefined range of states of charge when the request is received.

In yet another embodiment, a vehicle is provided with an engine, an electric machine, a traction battery electrically connected with the electric machine, and at least one controller. The at least one controller is configured to, in response to a user command to delay electric-only operation of the vehicle, selectively operate the electric machine and the engine to propel the vehicle such that a state of charge of the traction battery is generally maintained at a target value within a predefined range of states of charge.

Various embodiments of the present disclosure have associated non-limiting advantages. For example, the vehicle is configured to provide a user selected, delayed electric-only (EV) mode of operation, allowing user control and input regarding vehicle operation. The user may select the delayed EV mode, or charge sustain mode using a user interface. The controller is configured to change the operating state of the vehicle to a hybrid mode of operation. The controller operates the engine and the electric machine in a charge sustain mode such that the state of charge of the battery is generally maintained around a target value, which may include a window. The target value is within a state of charge range with an upper and lower threshold. If the state of charge is above the range when the user request is received, the state of charge is decreased until the state of charge is within the range such that a target value may be set. If the state of charge is below the range when the user request is received, the state of charge is increased until the state of charge is within the range such that a target value may be set. The range may be adjusted based on the vehicle speed and the road grade such that the upper threshold is decreased to provide headroom for battery charging caused by regenerative braking and the like.

### BRIEF DESCRIPTION OF THE DRAWINGS

FIG. 1 is a chart illustrating two modes of operation for a plug-in electric vehicle according to an embodiment;

FIG. 2 is a schematic of a hybrid vehicle capable of implementing various embodiments of the present disclosure;

FIG. 3 is a flow chart illustrating an algorithm for use with the vehicle of FIG. 2 for a user selected delayed EV mode of operation according to an embodiment; and

FIG. 4 is a graph illustrating various examples of the algorithm of FIG. 3 implemented for use; and

FIG. 5 is a graph illustrating another example of the algorithm of FIG. 3 implemented for use.

### DETAILED DESCRIPTION

As required, detailed embodiments of the present disclosure are disclosed herein; however, it is to be understood that the disclosed embodiments are merely exemplary and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

Plug-in hybrid electric vehicles (PHEV) utilize a larger capacity battery pack than a standard hybrid electric vehicle (HEV). PHEVs have the capability to recharge the battery from a standard electrical outlet or charging station connected to the external electric grid to reduce fuel consumption and to improve the vehicle's fuel economy. The PHEV structure is used in the figures and to describe the various embodiments below; however, it is contemplated that the various embodiments may be used with vehicles having other vehicle architectures as are known in the art. The PHEV engine may be a compression or spark ignition internal combustion engine, or an external combustion engine, and the use of various fuels is contemplated. In one example, the vehicle has the ability to connect to an external electric grid, such as in a plug-in electric hybrid vehicle (PHEV).

Besides the gasoline fuel energy, a PHEV also has an additional energy source of electrical energy stored in the battery, which may be electric energy from the electric grid deposited in the vehicle's battery during charging. The power management of the PHEV allocates the drive power demand of the vehicle to one or both of the two energy sources in order to achieve an improved fuel economy and meet the other comparable HEV/PHEV control objectives. While conventional HEVs may be operated in order to maintain the battery State of Charge (SOC) around a constant level, it may be desirable for PHEVs to use as much pre-saved battery electric (grid) energy as possible before the next charge event (when the vehicle is “plugged-in”). To increase fuel economy, the relatively inexpensive, grid-supplied electric energy may be preferentially used to save as much gasoline fuel as possible.

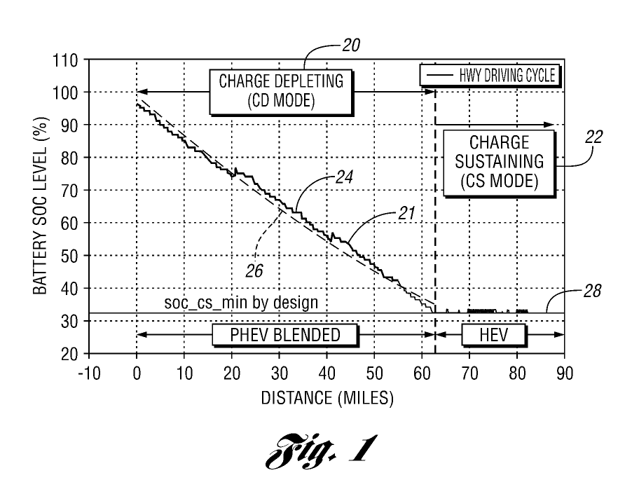

Generally, a PHEV has two basic operating modes as seen in FIG. 1. In a Charge Depleting (CD) mode 20 the battery electric energy 21 may be primarily used to propel the vehicle. The engine assists the vehicle drive power supply only in certain driving conditions or at excessive drive power requests during the basic charge depleting mode. One characteristic in the CD mode 20 is that the electric motor consumes more energy from the battery 21 than can be regenerated. In a Charge Sustaining (CS) mode 22 (or HEV mode), the vehicle reduces the electric motor propulsion usage to be able to keep the battery's State of Charge (SOC) 21 at a constant or approximately constant level by increasing the engine propulsion usage such that the SOC level is generally maintained.

The PHEV may operate in an Electric Vehicle (EV) mode where the electric motor is used (without help from the gasoline engine depending on PHEV strategy) for vehicle propulsion, depleting the battery up to its maximal allowable discharging rate under certain driving patterns/cycles. The EV mode is an example of a CD mode of operation for a PHEV. During an EV mode, the battery charge may increase in some circumstances, for example due to a period of regenerative braking The engine is generally not permitted to operate under a default EV mode, but may need to be operated based on a vehicle system state or as permitted by the operator through an override or hybrid operation selection as described further below.

For the vehicle operation as shown in FIG. 1, once the battery SOC 21 decreases to a predefined charge sustaining level 28, the vehicle switches to CS mode 22, where the battery SOC 21 is kept within a vicinity of the charge sustaining SOC level, and the vehicle is primarily powered by the engine (fuel energy). The vehicle may also operate with the CD and CS modes in any order, or with CD and CS modes occurring multiple times during a key cycle. Also, the CD mode may have various battery discharging rates, or slopes. For example, the vehicle may be operated in CS mode at a battery SOC above level 28, either based on a user selection, vehicle management, or the like, and then be operated in a CD mode to use additional battery power.

In order to extend PHEV operational flexibility, the user may have the ability to select a preferred PHEV operation mode actively between electric and hybrid operation (EV/HEV) to override the automatic mode where the vehicle controller selects an operational mode for the vehicle. This permits a user to control the vehicle emissions, noise, and the like along the trip, and control the source of the power used by the vehicle, i.e. gasoline vs. electricity. For example, the user may start by requesting an HEV driving mode 28 (battery charge sustaining at a high SOC off-charge) in the initial section of the trip. This saves the battery electric energy 21 such that the user can later switch to an EV driving mode 24 at another location where EV operation of the vehicle is desirable.

When the user selects a preferred PHEV operation mode using an interface in the vehicle, such as EV/HEV buttons, the user's inputs may disrupt the normal vehicle energy management strategy. The user has the freedom to actively manage the energy usage for his/her vehicle. The more a user uses the vehicle, the better he/she can understand the vehicle energy usage property, which will lead to familiarity and better optimization that the user can exercise with the battery energy usage tool. The manual energy planning feature will not only enable the user to simply select EV/HEV driving mode, but allows the user to actively plan the battery electric energy usage and fuel usage for the trip. Although the present disclosure describes the various embodiments in terms of a PHEV, any hybrid electric vehicle having an interface permitting the user to select or control the operating mode of the vehicle may be used.

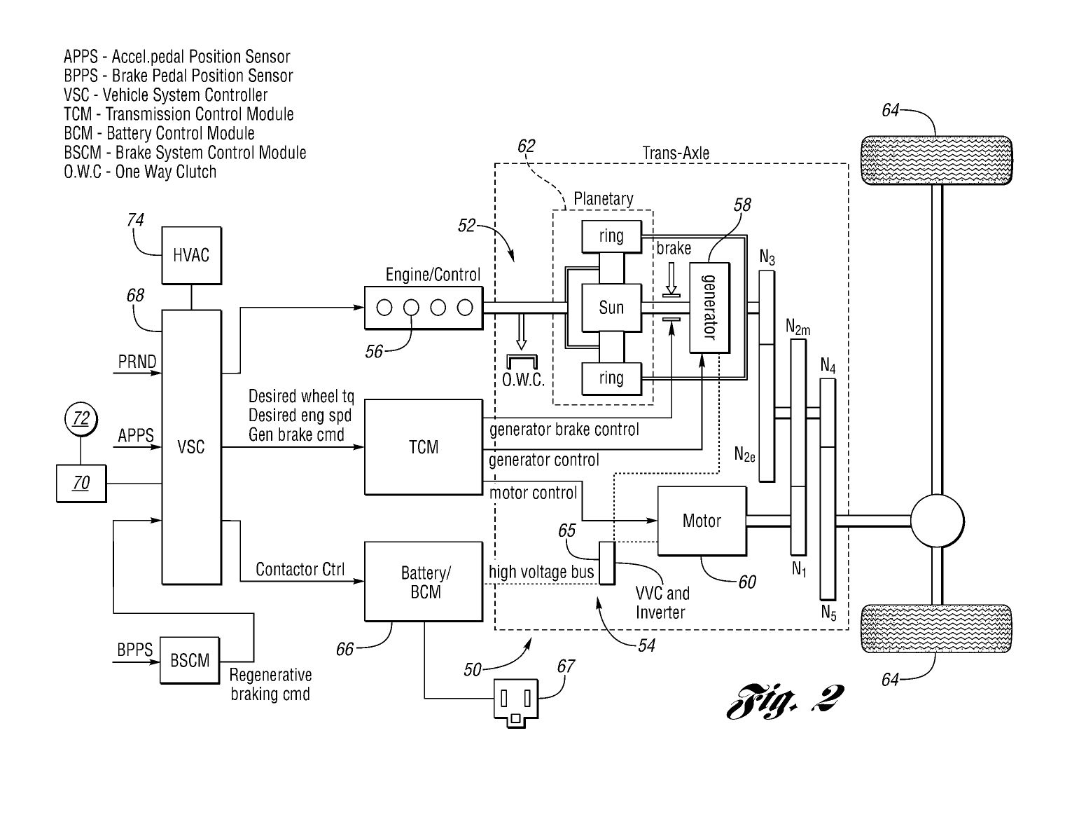

One example of a power split PHEV 50 capable of implementing the present disclosure is shown in FIG. 2. Of course, the PHEV 50 may be any hybrid vehicle as is known in the art that has an interface permitting the user to select or control the operating mode. FIG. 2 illustrates a power split hybrid electric vehicle 50 powertrain configuration and control system, which is a parallel hybrid electric vehicle. In this powertrain configuration, there are two power sources 52, 54 that are connected to the driveline. The first power source 52 is a combination of engine and generator subsystems using a planetary gear set to connect to each other. The second power source 54 is an electric drive system (motor, generator, and battery subsystems). The battery subsystem is an energy storage system for the generator and the motor and includes a traction battery.

During operation of the vehicle 50 using the second power source 54, the electric motor 60 draws power from the battery 66 and provides propulsion independently from the engine 56 to the vehicle 50 for forward and reverse motions. An inverter 65 may be positioned between the battery 66 and the electric machine 60 and generator 58. The inverter 65 may include a variable voltage converter as well. This operating mode is called “electric drive”. In addition, the generator 58 can draw power from the battery 66 and drive against a one-way clutch coupling on the engine output shaft to propel the vehicle forward. The generator 58 can propel the vehicle forward alone when necessary.

The operation of this power split powertrain system, unlike conventional powertrain systems integrates the two power sources 52, 54 to work together seamlessly to meet the user's demand without exceeding the system's limits (such as battery limits) while optimizing the total powertrain system efficiency and performance. Coordination control between the two power sources is needed.

As shown in FIG. 2, there is a hierarchical vehicle system controller (VSC) 68 that performs the coordination control in this power split powertrain system. Under normal powertrain conditions (no subsystems/components faulted), the VSC 68 interprets the user's demands (e.g. PRND and acceleration or deceleration demand), and then determines the wheel torque command based on the user demand and powertrain limits. In addition, the VSC 68 determines when and how much torque each power source needs to provide in order to meet the user's torque demand and achieve the operating point (torque and speed) of the engine.

The VSC 68, which includes an electronic control unit (ECU), is connected to or integrated with a human-machine interface (HMI) 70, or user interface. The user interface 70 may include a user input and a display. The user input may be touch screen and/or a series of tactile buttons. The display may be a screen and/or gauges for displaying information to the user.

The control system for the vehicle 50 may include any number of controllers, and may be integrated into a single controller, or have various modules. Some or all of the controllers may be connected by a controller area network (CAN) or other system.

The engine 56 is fueled by gasoline or another fuel contained in a fuel tank in fluid communication with the fuel injectors or another fuel delivery system for the engine 56. The fuel tank may be refueled by a user.

The battery 66 may be recharged or partially recharged using a charging adapter 67 connected to a charging station powered by an external power source, such as the electrical grid, a solar panel, and the like. In one embodiment, the charging adapter 67 contains an inverter and/or a transformer on-board the vehicle.

The VSC 68 may receive signals or inputs from various sources to control the vehicle. These inputs include a user selected vehicle mode and a vehicle state such as battery state, fuel level, engine temperature, oil temperature, tire pressure, and the like. Route and map information may also be provided to the VSC 68 from a navigation system, which may be incorporated into the user interface 70.

An EV button 72, or other user input of the user interface 70, provides for user selection of PHEV operation using electrical energy from the battery in an EV mode, resulting in a user selected EV mode. In the user selected EV mode, the PHEV operates in a charge depletion (CD) mode and the engine 56 may be disabled. The engine may be pulled up by the VSC 68 beyond predetermined vehicle power, speed, or other thresholds in an override of the user selected EV mode. The EV button 72 may be incorporated into the VSC 68 and the human machine interface 70 to allow the user to manually select between EV, HEV, and automatic operational modes for the vehicle. The button 72 allows the user to pre-determine and control the vehicle operation mode among EV, HEV, and automatic (VSC 68 selected) modes for a charge cycle or a key cycle.

The VSC 68 may also be in communication with a heating, ventilation, and air-conditioning system (HVAC) 74 for the vehicle. The HVAC system 74 may be in thermal communication with the engine 56, the engine coolant, the engine exhaust, an electric heater powered by the battery 66, and the like to provide heat to the passenger cabin, or to provide a defrost function for the vehicle as is known in the art.

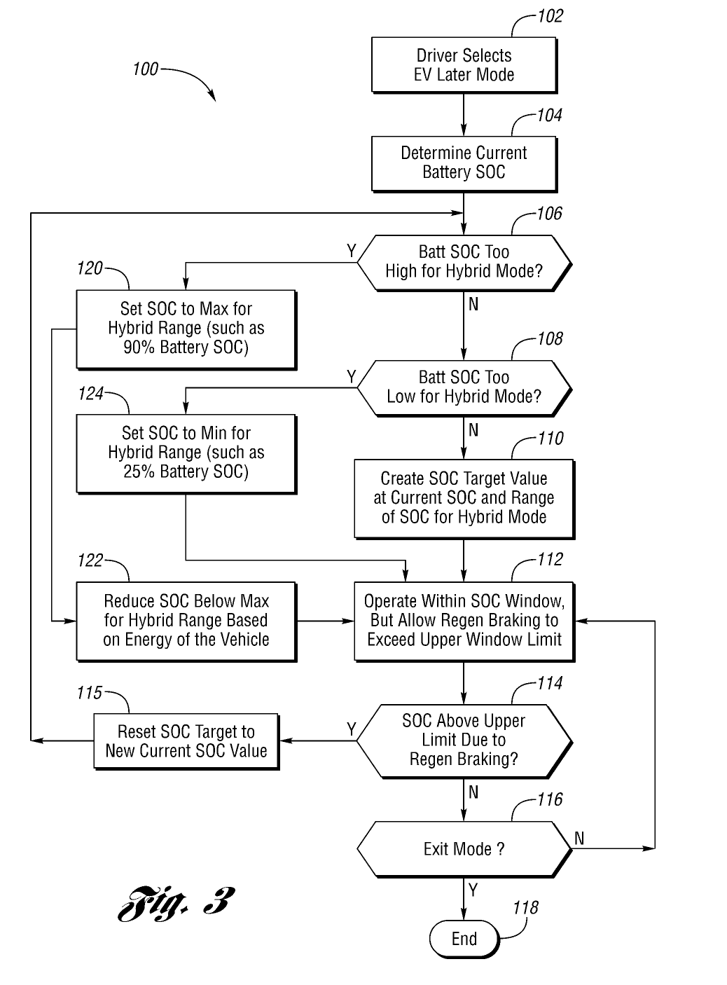

FIG. 3 illustrates an embodiment of an algorithm 100 for implementing a user selected delayed EV mode, EV later, forced charge sustain, or hybrid mode of operation of the vehicle, all of which refer to the same mode of operation with respect to algorithm 100. The algorithm 100 provides for user selection of an EV later mode or forced charge sustain mode, which acts to delay the operation of the vehicle in EV mode. After the user request for a forced charge sustain mode, the vehicle is generally operated in a hybrid mode of operation with both the engine 56 and the electric machine 60 selectively operating, such as a charge sustain mode. The algorithm 100 causes the engine 56 to be enabled such that the vehicle can operate in a user selected hybrid mode of operation. The algorithm 100 may return to an automatic mode or an EV mode of operation based on the user exiting the delayed EV mode.

The algorithm 100 begins at 102, where the user selects a delayed EV mode of operation for the vehicle. For a user selected delayed EV mode in one embodiment, the user has requested delayed EV mode using the input 72 through the user interface 70 such that the vehicle may be commanded to operate in a hybrid mode of operation. The controller 68 may determine if the vehicle is operating in forced charge sustain mode based on the switch input from 72, as well as other vehicle states such as the engine 56 being enabled and the electric machine 60 being enabled or operating.

If the vehicle is operating in a delayed EV mode at 102, the controller 68 proceeds to determine the battery 66 state of charge (SOC) at 104. Then at 106, the controller 68 determines if the battery SOC is too high for the delayed EV mode, or the hybrid mode of operation. The battery 66 has an upper threshold limit for hybrid operation. This upper limit is set at a value below 100% SOC for the battery. The upper threshold is the highest SOC that the vehicle is permitted to operate in a hybrid or charge sustain mode of operation. If the battery SOC is between the upper threshold and 100% charge, the vehicle will be commanded to operate in an EV mode, or charge depletion mode. The upper threshold and modes of operation across the threshold are implemented because any charging of the battery, such as from regenerative braking, may be recovered. Note that the battery 66 SOC is not permitted to exceed 100%.

If the battery SOC is below the upper threshold at 106, the controller 68 proceeds to 108 to determine if the battery SOC is below a lower threshold. The lower threshold is set at a value above 0% SOC for the battery. When the battery SOC is below the lower threshold, the vehicle is typically operated such that the battery 66 is charged, thereby increasing the battery SOC.

If the battery SOC is not below the lower threshold at 108, the controller 68 proceeds to 110 to create a SOC target value for the vehicle. The SOC target value is set as the current SOC value for the vehicle, i.e. the SOC when the user selected delayed EV mode with a SOC between the upper and lower thresholds. The upper and lower thresholds create the outer limits of a predefined range of states of charge where the user selected forced charge sustain mode may be used. A window may be also set for the SOC at 110. The SOC is set to the target value and generally allowed to vary within the window. In one embodiment, the window is set as six percent SOC such that the SOC could go above or below the target value by three percent SOC. Of course, in other embodiments, other values or metrics windows may be selected.

At 112, the controller 68 operates the vehicle in a hybrid mode, such as a charge sustaining mode of operation, in response to the user selected delayed EV mode. The controller 68 enables the engine 56 and the electric machine 60. The engine 56 and/or the electric machine 60 are operated such that the battery SOC is generally maintained at the target value, and within the window. If the vehicle has excess charging energy, such as from regenerative braking, the controller 68 permits the battery SOC to exceed the upper window limit to capture the regenerative energy.

In the delayed discharge mode or hybrid mode, the vehicle operates with the battery SOC programmed to stay within a defined percentage window, such that the SOC is generally maintained within that window. The target value for the charge sustaining mode depends on when the mode was selected, and the window is a calibrateable value. In one embodiment, the window is approximately six percent of the SOC where the forced charge sustaining mode was entered.

At 114, the controller 68 determines if the upper limit of the window was exceeded due to regenerative braking or the like. If the window was not exceeded, the controller 68 proceeds to 116 to determine if the user has exited the delayed EV mode, for example, using the switch 72 or user interface 70. If the user has not exited the delayed EV mode or hybrid mode, the algorithm 100 returns to block 112. If the user has exited the delayed EV mode, the algorithm 100 ends at 118.

If the window was exceeded at 114, the algorithm 100 resets the target SOC value to the current, higher, SOC value at 115. This serves to store the extra regenerative energy. The higher target SOC value has an associated percentage window. From 115, the algorithm 100 returns to block 106.

Referring back to 106, if the battery SOC is above the upper threshold, such that the battery SOC is too high for the vehicle to operate in a delayed EV or hybrid mode of operation, the algorithm 100 proceeds to 120. At 120, the controller 68 sets a target SOC of the upper threshold for hybrid operation. At 122, the controller 68 operates the engine 56 and the electric machine 60 such that the battery SOC goes below the upper threshold. The vehicle may be operated in a charge depleting mode such that the battery SOC is reduced below the upper threshold, or to within the predefined range of states of charge for charge sustain mode. The battery SOC may be reduced below the upper threshold by an offset amount. The offset amount may be based on the amount of predicted regenerative energy that the vehicle has, as this is related to the amount of energy that could be recovered by regenerative braking This could also be viewed as reducing the upper threshold for the battery SOC by an amount related to the kinetic energy of the vehicle. From block 122, the algorithm proceeds to 112 to operate in a charge sustain mode.

At 122, if the delayed EV mode or forced charge sustaining mode was selected when the battery SOC was at 100% SOC or above the upper threshold, then the algorithm 100 reduces the SOC to a maximum value, i.e. the upper threshold, where charge sustaining can be met with full battery charge limits.

In one embodiment at 122, energy gained by the vehicle may cause the upper threshold to be adjusted or the algorithm to implement an offset to the upper threshold. For example, the vehicle may gain energy through regenerative braking by recovering the kinetic energy of the vehicle. Also, the vehicle may gain energy through regenerative braking by recovering potential energy of the vehicle, for example, by going downhill for a period of time. The predicted regenerative energy is amount of energy that the vehicle may recover from regenerative braking kinetically and/or potentially to increase the SOC.

If the energy recovered by the vehicle will cause the battery SOC to go above the upper threshold, the algorithm adjusts the upper threshold by subtracting the predicted SOC change that would occur due to the recovered vehicle energy. For example, if a moving vehicle is brought to a stop, the kinetic energy would be largely converted to battery energy with the regenerative braking system. The kinetic energy of a vehicle is 0.5*mass*velocitŷ2, neglecting losses. In one example, a 2000 kg vehicle traveling at 27 m/s (approx. 60 mph) has 1/2*2000*27*27=730,000 joules=0.18 kilowatt hour of kinetic energy. Assuming 10% SOC is approximately equal to 1 kWh and the upper threshold is 90%, the set SOC would be 90%−2%=88%. The calculation of the energy that may be recovered by the vehicle may also be further modified based on the grade that the vehicle is currently traveling over to provide the potential energy component. For example, downhill driving increases the potential energy and uphill driving decreases the potential energy. These calculations to modify vehicle energy based on grade are known to those skilled in the art.

In a further embodiment at 122, the predicted regenerative energy of the vehicle may cause the upper threshold to be adjusted or the algorithm 100 to implement an offset to the upper threshold. For example, if the predicted route for the vehicle has a negative grade (i.e. downhill) within a specified distance (i.e. within the next 2 miles), the algorithm 100 may calculate the predicted regenerative energy by maintaining vehicle speed over that grade. The algorithm 100 then reduces the battery SOC below the upper threshold appropriately. The predicted grade may be determined from route information, such as a navigation system in the user interface 70, from global positioning information, possible routes that the vehicle may take, and the like. The predicted route information may include an overall grade as well as terrain information. The battery SOC target value may be allowed to decrease by an amount that provides a headroom or an offset below the upper threshold. In one example, the upper threshold is 90% and the SOC target is currently at 88%. The vehicle is approaching a downhill grade that is predicted to add 6% from regenerative energy to the battery SOC. The algorithm 100 sets the new target value for the battery SOC to 84%, using the 6% as the offset or headroom. In the same example, if the battery SOC target value is currently at 60%, the SOC target value is unchanged because there is sufficient headroom or battery SOC difference below the upper threshold (90%) to absorb the regenerative energy.

Referring to back 108, if the battery SOC is below the lower threshold, such that the battery SOC is too low for the vehicle to operate in a delayed EV or hybrid mode of operation, the algorithm 100 proceeds to 124. At 124, the controller 68 sets a target SOC of the lower threshold for hybrid operation. At 124, the controller 68 operates the engine and the electric machine such that the battery SOC goes above the lower threshold, or to within the predefined range of states of charge for charge sustain mode. For example, at the lower threshold and in a forced charge sustaining mode, the discharge power limit needs to be ramped out to force the vehicle system controller 68 to command the engine 56 to charge the battery and stay in the range for the charge sustaining mode. The vehicle may be operated in a charging mode such that the battery SOC is increased. From block 124, the algorithm proceeds to 112 to operate in a charge sustain mode.

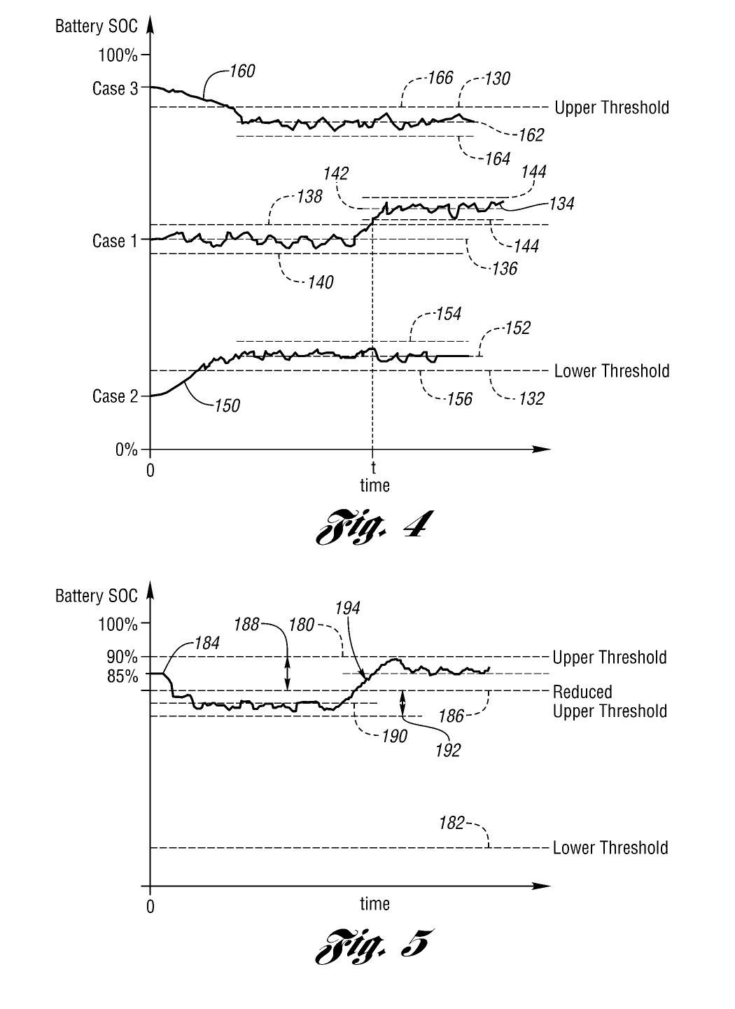

FIG. 4 illustrates various examples of implementation of the algorithm 100 as shown in FIG. 3. FIG. 4 plots battery SOC as a percentage against time. The battery 66 state of charge apparent to a user may range between 0% and 100%. Note that 0% is not necessarily 0% battery state of charge, but may represent the lowest battery state of charge between charge depleting and charge sustaining modes of operation. The upper threshold is shown by line 130, which represents the highest level the vehicle is permitted to operate in charge sustaining mode by the algorithm 100. The lower threshold 132 represents the lowest level that the vehicle is permitted to operate in charge sustaining mode by the algorithm 100. In one embodiment, the upper threshold 130 is 90% and the lower threshold 132 is 25%. Other values for the upper and lower thresholds, or the predefined range of states of charge for charge sustain mode, are also contemplated for use with the algorithm 100.

A first example is shown by line 134. The user selects a delayed EV mode at time zero. The controller 68 determines the battery SOC as being between the lower and upper thresholds 130, 132, and at a value of 55%. The target value 136 is set to be 55%, with a window of 6%, such that there is an upper window limit 138 and a lower window limit 140. The controller 68 operates the engine 56 and the electric machine 60 such that the battery SOC remains within the window and meets the user request for a hybrid mode of operation. At a later time, t, the vehicle has sufficient regenerative braking energy to raise the battery SOC above the upper window limit 140. The controller 68 allows the regenerative energy to be captured to charge the battery 66 and lets the battery SOC increase above the upper window limit 140. The controller 68 then sets a new target value 142 for the battery SOC along with a new window 144 and operates the vehicle in a charge sustaining mode within the new window 144.

Another example is shown by line 150. The user selects a delayed EV mode at time zero. The controller 68 determines the battery SOC as being below the lower threshold 132, and at a value of 20%. The controller 68 operates the vehicle in a charging mode such that the engine 56 and the electric machine 60, as well as any regenerative braking and the like, are used to charge the battery to increase the SOC above the lower threshold 132. When the battery SOC increases above the lower threshold 132, the controller 68 sets a target value 152. In the example shown, the target value is 28%, with a window of 6%, such that there is an upper window limit 154 and a lower window limit 156 which corresponds to the lower threshold 132. The controller 68 operates the engine and the electric machine such that the battery SOC remains within the window limits 154, 156 and meets the user request for a hybrid mode of operation.

Yet another example is shown by line 160. The user selects a delayed EV mode at time zero. The controller 68 determines the battery SOC as being above the upper threshold 130, and at a value of 95%. The controller 68 operates the vehicle in a charge depleting mode such that the engine and the electric machine are used to discharge the battery to decrease the SOC below the upper threshold 130. In one embodiment, the vehicle is operated in an EV mode temporarily to reduce the SOC below the upper threshold 130. When the battery SOC decreases below the upper threshold 130, the controller 68 sets a target value 162. In the example shown, the target value is 87%, with a window of 6%, such that there is a lower window limit 164 and an upper window limit 166 which corresponds to the upper threshold 130. The controller 68 operates the engine and the electric machine such that the battery SOC remains within the window limits 164, 166 and meets the user request for a hybrid mode of operation.

FIG. 5 illustrates an example of the algorithm 100 where an offset or headroom is used with the upper threshold. FIG. 5 plots battery SOC as a percentage against time. The upper threshold 180 and lower threshold 182 are shown and are set as 90% and 25% respectively. The user selects a delayed EV mode at time 0. The controller 68 determines the battery SOC 184 as being below the upper threshold 180, and at a value of 85%. The controller 68 then determines that the vehicle speed and road grade provide energy that may be recovered through regenerative braking of 10%. Since recovering the predicted regenerative energy would lead to the battery SOC going above the upper threshold 180 to a value of 95%, the algorithm 100 sets a headroom or offset to the upper threshold. This essentially reduces or adjusts the upper threshold. The reduced upper threshold 186 is set as 80%, since there is headroom 188 of 10%. The target value 190 is set to be below this reduced upper threshold 186, and has an operating window 192. In the example shown, the window 192 is 6% such that the target value is 77%. The controller operates the engine and electric machine in a charge depleting mode until the battery SOC reaches the target value 190, and then operates the vehicle in a charge sustaining mode within the window 192. As the vehicle kinetic energy changes, or the predicted regenerative energy changes, the headroom 188 may also be altered.

When the vehicle comes to rest or reduces speed, the battery SOC will be allowed to increase, thereby capturing energy to charge the battery. In the example shown, the vehicle comes to rest such that all of the energy from vehicle speed and road grade is captured, minus any losses. The battery SOC is allowed to increase, as shown by region 194, and goes above the reduced upper threshold 186. The algorithm then resets the target value and window. In the example shown, the target value is 87% with a window of 6% such that the upper window limit and upper threshold correspond.

Various embodiments of the present disclosure have associated non-limiting advantages. For example, the vehicle is configured to provide a user selected, delayed electric-only (EV) mode of operation, allowing user control and input regarding vehicle operation. The user may select the delayed EV mode, or charge sustain mode using a user interface. The controller is configured to change the operating state of the vehicle to a hybrid mode of operation. The controller operates the engine and the electric machine in a charge sustain mode such that the state of charge of the battery is generally maintained around a target value, which may include a window. The target value is within a state of charge range with an upper and lower threshold. If the state of charge is above the range when the user request is received, the state of charge is decreased until the state of charge is within the range such that a target value may be set. If the state of charge is below the range when the user request is received, the state of charge is increased until the state of charge is within the range such that a target value may be set. The range may be adjusted based on the vehicle speed and the road grade such that the upper threshold is decreased to provide a headroom for battery charging caused by regenerative braking and the like.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments that are not explicitly illustrated or described. Where one or more embodiments have been described as providing advantages or being preferred over other embodiments and/or over prior art with respect to one or more desired characteristics, one of ordinary skill in the art will recognize that compromises may be made among various features to achieve desired system attributes, which may depend on the specific application or implementation. These attributes include, but are not limited to: cost, strength, durability, life cycle cost, marketability, appearance, packaging, size, serviceability, weight, manufacturability, ease of assembly, etc. As such, any embodiments described as being less desirable relative to other embodiments with respect to one or more characteristics are not outside the scope of the claimed subject matter.

What is claimed is:

1. A method for controlling a vehicle comprising:
in response to a user command to delay electric-only operation of the vehicle, selectively operating an electric machine and an engine to propel the vehicle such that a state of charge of a traction battery electrically connected with the electric machine is generally maintained at a target value if the state of charge is within a predefined range of states of charge when the user command is received.

2. The method of claim 1 wherein the target value is defined by the state of charge when the user command is received

3. The method of claim 2 wherein the state of charge of the traction battery is maintained within a predetermined percentage of the target value.

4. The method of claim 1 further comprising selectively operating the electric machine and engine to propel the vehicle such that the state of charge increases to a predefined value within the predefined range if the state of charge is below the predefined range when the user command is received.

5. The method of claim 1 further comprising selectively operating the electric machine and engine to propel the vehicle such that the state of charge decreases to a predefined value within the predefined range if the state of charge is above the predefined range when the user command is received.

6. The method of claim 1 wherein the predefined range is based on vehicle speed information.

7. The method of claim 1 wherein the predefined range is based on road grade information.

8. The method of claim 5 wherein the predefined range is based on predicted road grade information and predicted vehicle speed information.

9. The method of claim 1 further comprising, in response to the vehicle having captured sufficient regeneration energy to increase the state of charge above the target value, selectively operating the engine and the electric machine within the predefined range of states of charge such that the target value is reassigned to the state of charge after regenerative braking

10. A vehicle comprising:
a powertrain including an engine, an electric machine, and a traction battery electrically connected with the electric machine; and
at least one controller configured to (i) operate the powertrain in each of a charge deplete mode in which a state of charge of the traction battery generally decreases and a charge sustain mode in which a state of charge of the traction battery is generally maintained and (ii) in response to a user request, operate the powertrain in the charge sustain mode if the state of charge is within a predefined range of states of charge when the request is received.

11. The vehicle of claim 10 wherein the at least one controller is further configured to operate the powertrain such that the state of charge increases to a predefined value within the predefined range if the state of charge is below the predefined range when the request is received.

12. The vehicle of claim 10 wherein the at least one controller is further configured to operate the powertrain such that the state of charge decreases to a predefined value within the predefined range if the state of charge is above the predefined range when the request is received.

13. The vehicle of claim 10 wherein the at least one controller is further configured to, in response to a subsequent user request, operate the powertrain in the charge deplete mode.

14. The vehicle of claim 10 wherein the predefined range is based on vehicle speed information.

15. The vehicle of claim 10 wherein the predefined range is based on road grade information.

16. A vehicle comprising:
an engine;
an electric machine;
a traction battery electrically connected with the electric machine; and
at least one controller configured to, in response to a user command to delay electric-only operation of the vehicle, selectively operate the electric machine and the engine to propel the vehicle such that a state of charge of the traction battery is generally maintained at a target value within a predefined range of states of charge.

17. The vehicle of claim 16 wherein the target value is defined by the state of charge when the user command is received if the target value is within the predefined range of state of charge.

18. The vehicle of claim 16 wherein the at least one controller is further configured to selectively operate the electric machine and engine to propel the vehicle such that the state of charge increases to a predefined value within the predefined range if the state of charge is below the predefined range when the user command is received.

19. The vehicle of claim 16 wherein the at least one controller is further configured to selectively operate the electric machine and engine to propel the vehicle such that the state of charge decreases to a predefined value within the predefined range if the state of charge is above the predefined range when the user command is received.
